(19) United States
(12) Patent Application Publication
(10) Pub. No.: US 2018/0198834 A1
(43) Pub. Date: Jul. 12, 2018

(54) METHOD FOR TRANSMITTING A DATA STREAM USING A STREAMING PROTOCOL

(71) Applicant: SAGEMCOM BROADBAND SAS, RUEIL MALMAISON (FR)

(72) Inventor: Frédéric SODI, RUEIL MALMAISON (FR)

(73) Assignee: SAGEMCOM BROADBAND SAS, RUEIL MALMAISON (FR)

(21) Appl. No.: 15/541,133

(22) PCT Filed: Jan. 14, 2016
(86) PCT No.: PCT/EP2016/050697

§ 371 Date: Jun. 30, 2017

(30) Foreign Application Priority Data
Jan. 16, 2015 (FR) 1550342

(51) Int. Cl. H04L 29/06; H04L 29/08; H04N 21/845; H04N 21/2343; H04N 21/258

(52) U.S. Cl. CPC H04L 65/601; H04L 65/608; H04L 67/02; H04N 21/25833; H04N 21/8456; H04N 21/2343; H04N 21/25825; H04L 67/42

(57) ABSTRACT

Method for transmitting a data stream between a server and a client using the streaming protocol based on HTTP including the following steps implemented by the server following a reception of at least one item of information representing a capacity of said client: adapting an initial data stream to each capacity received in order to obtain an adapted data stream; decomposing the adapted data stream into segments; transmitting to the client an item of descriptive information making it possible to obtain, for each segment, a loading address of said segment, said descriptive information enabling the client to request from the server a transmission of the segments in order to obtain the adapted data stream.

The present invention relates to a method for transmitting a data stream using a streaming protocol, such as for example the streaming protocol based on HTTP (“HTTP live streaming (HLS)”, informational Internet Draft, R. Pantos, Apple Inc., Oct. 14, 2014, draft-pantos-http-live-streaming-14). The invention also relates to a server device, a client device and a system implementing said method.

Protocols for streaming data streams between a server and a client in which the sending of a data stream is at the initiative of the client are known. This is the case for example with the HTTP-based streaming protocol, hereinafter referred to as the HLS protocol. The HLS protocol allows to stream audio streams, video streams, metadata streams and streams combining several types of data stream.

A sending of a data stream using the HLS protocol begins with a reception by the server of an HTTP request coming from a client. This request requires a sending of one of the data streams available on the server. Hereinafter this data stream is referred to as the initial data stream. The server then initiates a decomposition of the initial data stream into segments. Each segment represents a duration of display less than or equal to a constant fixed by the HLS protocol. Each segment is associated with an address such as an URI (uniform resource identifier) enabling a client to obtain the segment. Moreover, each segment is associated with a sequence number and a duration, which allows to reorder the segments. Following the initiation of the decomposition, the server creates a text file referred to as a playlist file, according to a format specified by the HLS protocol. The URI address, the sequence number and the duration of each segment that the server wishes to make available for a client appear in the playlist file. A URI address is next created for the playlist file, so as to enable a client to obtain the playlist file. The playlist file can be updated by the server according to the availability of the segments constituting the data stream. The end of a data stream is indicated in the playlist file by a particular segment referred to as the final segment.

The HLS protocol allows to send real-time data streams, i.e. data streams created as they are sent, or data streams that are completely pre-existent before the start of the sending. In the case of a real-time data stream, the playlist file is supplied during the sending by information (URI address, sequence number, duration) relating to new segments, the information relating to the older segment being able to be removed from said playlist file. In the case of a pre-existing data stream, the playlist file may comprise information relating to each segment constituting the data stream.

In order to respond to multiple clients having different capacities, the HLS protocol enables a server to create a plurality of different versions of the same initial data stream. Each data stream thus created, hereinafter referred to as the first data stream, is decomposed into segments. A playlist file is then created for each first data stream. In this case, the server creates a master playlist file containing the URIs of each of the playlist files and for each playlist file the server inserts a description of the corresponding first data stream. The description of a first data stream comprises for example a transmission rate of the first data stream. The server associates the master playlist file with a URI, thus enabling a client to obtain the master playlist file.

For its part, a client of a session of sending a data stream according to the HLS protocol obtains, for example when an HTTP connection with a server is opened, a description of each data stream available on the server. This description enables the client to select one of the data streams available on the server. When it has selected one of the data streams, the client transmits information representing the selected data stream to the server and in return receives a URI address of a playlist file (or of a master playlist file) corresponding to said data stream selected. The data stream selected then corresponds to the initial data stream from the point of view of the server. The client then transmits to the server an HTTP request containing the URI address of the playlist file (or respectively of the master playlist file) in order to receive said playlist file (or respectively said master playlist file). When the client receives a master playlist file, the client selects a first data stream compatible with capacities of said client using the description associated with each first data stream contained in the master playlist file. The client next transmits an HTTP request to the server containing the URI address of the playlist file corresponding to the first data stream selected. As soon as it obtains a playlist file, the client can transmit HTTP requests to the server each containing a URI address of a segment that it wishes to receive. Each segment is requested in an order that is dependent on its sequence number. When a client that has received a master playlist file has variable capacities, for example variable rate capacities, it can alternate between a plurality of first data streams according to its capacities at a given instant.

In the HLS protocol, the server is responsible for defining adaptation parameters to be applied to the initial data stream in order to obtain each first data stream. The adaptation parameters are defined without dialogue with a client, taking into account the capacities of client types belonging to a predefined set of client types. The HLS protocol was defined initially for a context in which a server had to stream a data stream to a large number of clients. Allowing the server to define the adaptation parameters on the basis of a predefined set of client types is particularly coherent in this context since, for a computing cost reason, it is impossible for a server to generate the same number of data streams as there are different clients.

Through the years, the HLS protocol has been used in contexts other than the initial context for which it was defined. Thus, whereas the HLS protocol was generally used for sending data streams to clients actually corresponding to a client type belonging to the predefined set of client types, it is now used for other clients having capacities different from those of the client types in the predefined set of client types. Moreover, the HLS protocol is now used for streaming data streams in networks comprising a small number of clients.

It is desirable to overcome these drawbacks of the prior art.

It is in particular desirable to provide a streaming protocol allowing a fine adaptation of a data stream to a client not corresponding to a client type in the predefined set of client types. It is particularly desirable for the streaming protocol to be compatible with the HLS protocol.

It is in addition desirable to provide a solution that is simple to implement at low cost.

According to a first aspect of the present invention, the present invention relates to a method for transmitting a data stream between a server and a client using a streaming protocol, the method comprising the following steps implemented by the server: obtaining an initial data stream; receiving a request for descriptive information for the initial data stream from said client; checking that at least one item of information representing a capacity of said client has been received from said client; if no information representing a capacity of said client has been received: adapting the initial data stream in order to obtain a plurality of first data streams, each first stream being adapted to respective capacities of a client type belonging to a set of predefined client types; decomposing each first data stream into segments, referred to as first segments; and transmitting to said client a first item of descriptive information enabling the client to request a transmission of first segments of at least one first data stream; and, if at least one item of information representing a capacity of said client has been received: adapting said initial data stream to each capacity received in order to obtain a second data stream; decomposing the second data stream into segments, referred to as second segments; and transmitting to the client a second item of descriptive information enabling the client to request a transmission of second segments of the second data stream.

In this way, the second client receives a second data stream adapted finely to its capacities.

In one embodiment, the streaming protocol is the streaming protocol based on HTTP.

The method according to the invention can therefore be implemented by servers and clients able to implement the streaming protocol based on HTTP.

In one embodiment, the second item of descriptive information is put in the form of a playlist file compatible with the streaming protocol.

A client able to read a playlist file compatible with the streaming protocol would therefore be able to read the playlist file containing the second item of descriptive information.

In one embodiment, the transmission of the second item of descriptive information comprises a transmission to the client of an address for loading the playlist file compatible with the streaming protocol.

In one embodiment, the server transmits the playlist file compatible with the streaming protocol to the client following a reception, from the client, of an HTTP request containing said loading address.

In one embodiment, the server transmits a second segment following a reception, from the client, of an HTTP request containing a loading address corresponding to said second segment, said loading address having been obtained from the playlist file compatible with the streaming protocol.

In one embodiment, the capacities of the client comprise a supported video compression format and/or a supported audio compression format and/or a supported image compression format and/or a supported subtitle format and/or a network type used and/or a reception rate and/or a supported maximum image resolution and/or a supported number of audio channels.

In one embodiment, when said initial data stream comprises a video stream encoded in a first video compression format, an adaptation of said initial data stream comprises a transcoding for reducing a transmission rate of said video stream and/or an image resolution of said video stream and/or an image resolution of said video stream and/or a transformation of said video stream so as to ensure compatibility with a second video compression format, and, when said initial data stream comprises an audio stream encoded in a first audio compression format, an adaptation of said initial data stream comprises a transcoding for reducing a transmission rate of said audio stream and/or a number of channels and/or a transformation of said audio stream in order to ensure compatibility with a second audio compression format.

According to a second aspect of the present invention, the invention relates to a device of the server type able to transmit a data stream using a streaming protocol, comprising the following means: obtaining means for obtaining an initial data stream; reception means for receiving a descriptive information request for the initial data stream from a client; verification means for verifying that at least one item of information representing a capacity of said client has been received; means used when no information representing a capacity of said client has been received, comprising: adaptation means for adapting the initial data stream for obtaining a plurality of first data streams, each first data stream being adapted to respective capacities of a client type belonging to a predefined set of client types; decomposition means for decomposing each first data stream into segments, referred to as first segments; and transmission means for transmitting to a client a first item of descriptive information enabling the client to request a transmission of the first segments of at least one first data stream; means used when at least one item of information representing a capacity of said client has been received, comprising: adaptation means for adapting said initial data stream to each capacity received in order to obtain a second data stream; decomposition means for decomposing the second data stream into segments, referred to as second segments; and transmission means for transmitting to the client a second item of descriptive information enabling the client to request a transmission of second segments of the second data stream.

According to a third aspect of the present invention, the invention relates to a device of the client type able to receive a data stream using the streaming protocol based on HTTP, comprising the following means: transmission means for transmitting at least one item of information representing a capacity of said client device to a server; means for receiving a text file compatible with the streaming protocol based on HTTP, the text file corresponding to an initial data file and allowing to obtain loading addresses of segments corresponding to a data stream, referred to as the second data stream, resulting from an adaptation by the server of the initial data stream to each capacity of said client-type device; transmission means for transmitting a request containing a loading address of a segment of the second data stream, the loading address having been obtained from the text file compatible with the streaming protocol based on HTTP; reception means for receiving the segment corresponding to the request transmitted.

According to a fourth aspect of the present invention, the invention relates to a system for transmitting a data stream comprising a server according to the second aspect of at least one client according to the third aspect.

According to a fifth aspect of the present invention, the invention relates to a computer program comprising instructions for the implementation, by a device, of the method according to the first aspect, when said program is executed by a processor of the device.

According to a sixth aspect of the present invention, the invention relates to storage means, storing a computer program comprising instructions for the implementation, by a device, of the method according to the first aspect, when said program is executed by a processor of said device.

The features of the invention mentioned above, as well as others, will emerge more clearly from a reading of the following description of an example embodiment, said description being given in relation to the accompanying drawings, among which:

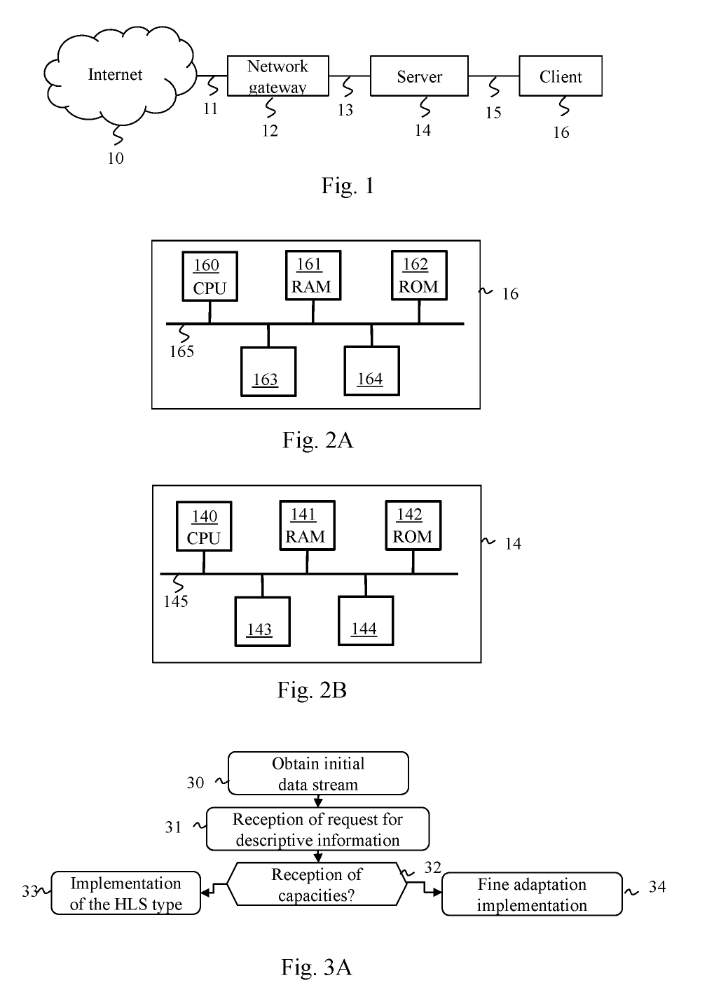

FIG. 1 illustrates schematically an example of a system in which a data transmission method using a streaming protocol is implemented;

FIG. 2A illustrates schematically an example of hardware architecture of a client device implementing the invention;

FIG. 2B illustrates schematically an example of hardware architecture of a server device implementing the invention;

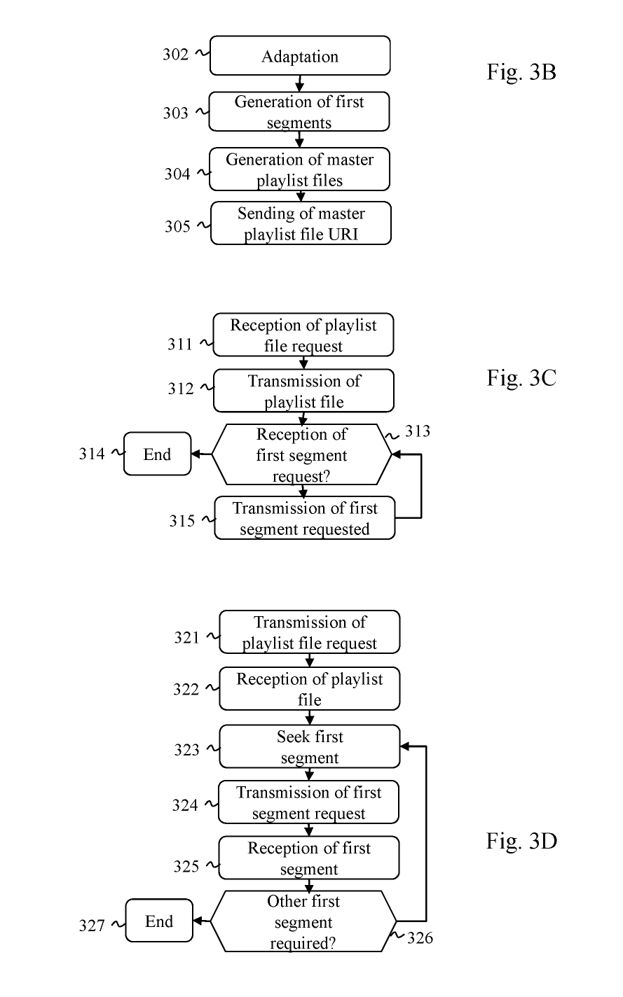

FIG. 3A illustrates schematically an example of implementation of a method according to the invention;

FIGS. 3B and 3C illustrate schematically an example of implementation of the method of the HLS protocol type by a server;

FIG. 3D illustrates schematically an example of implementation of a method of the HLS protocol type by a client;

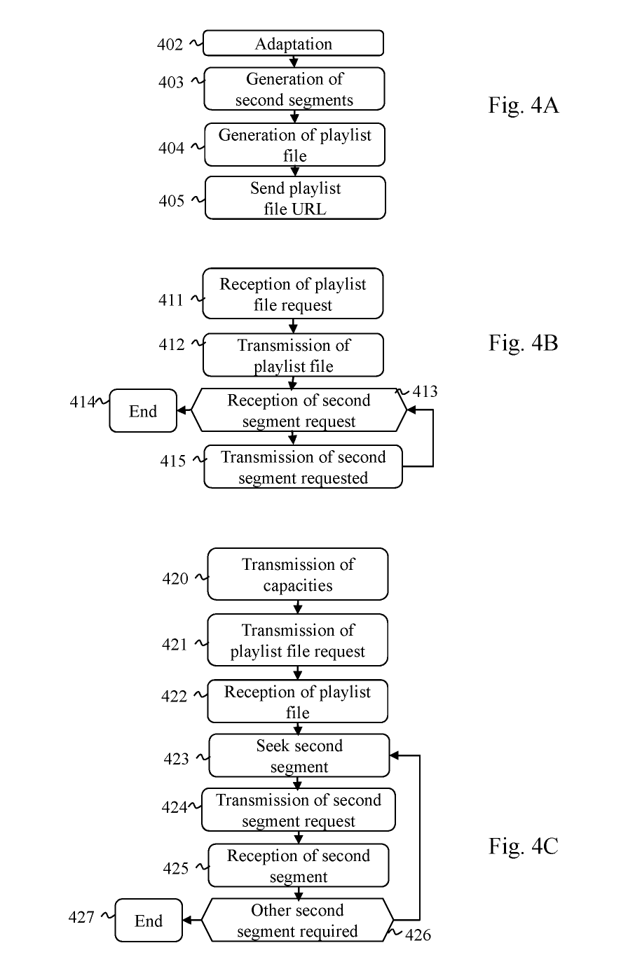

FIGS. 4A and 4B illustrate schematically an example of an implementation by a server of a method for streaming a data stream allowing a fine adaptation of the data stream to capacities of a client; and

FIG. 4C illustrates schematically an example of an implementation by a client of the method for streaming a data stream allowing a fine adaptation of the data stream to the capacities of the client.

Hereinafter the invention is described in the context of the HLS protocol. The invention is however suited to other protocols or methods for streaming data streams between a server and at least one client having a functioning similar to the HLS protocol. Moreover, the invention is described in the context of a local network (“local area network”) in which a multimedia server (set top box) obtains a data stream from a network, such as the internet, through a network gateway, and broadcasts data streams to clients of the local network. The invention is however suited to other contexts in which a server sends a data stream through a network to at least one client.

FIG. 1 illustrates schematically an example of a system in which a data transmission method using a streaming protocol is implemented. The system comprises a network gateway 12 connected by a network connection 11, such as an Ethernet connection, to a network 10 such as the internet. The network gateway 12 is an entry point to a local network. This local network comprises a server 14, such as a multimedia server or a TV decoder, connected to the network gateway 12 by a network connection 13 such as an Ethernet connection, a wireless connection or a powerline connection. The server 14 is connected to a client 16 by a network connection 15, such as an Ethernet connection, a wireless connection or a powerline connection. The client 16 may for example by a television set, a computer, a tablet or a smartphone.

The network gateway 12 receives data streams encapsulated in TCP (transmission control protocol, RFC 793), RTP (real-time transmission protocol, RFC 1889) or UDP (user datagram protocol) packets. Each data stream is next extracted from the packets by the network gateway 12 and supplied to the server 14 in the form of MPEG TS (“Moving Picture Expert Group Transport Stream Part 1”, ISO/IEC 13818-1) transport streams. Each MPEG TS transport stream may contain at least one video stream and/or at least one audio stream and/or at least one metadata stream such as a subtitle stream. When the client 16 chooses an initial data stream available on the server 14, the server 14 generates a plurality of first data streams in accordance with a method that we describe in relation to FIG. 3B. After a selection by the client 16 of one of the first data streams, a broadcast of the first selected data stream, in accordance with a method described in relation to FIGS. 3C and 3D, is implemented.

FIGS. 4A, 4B and 4C describe a variant of the methods described in relation to FIGS. 3A, 3B and 3C, this variant allowing a fine adaptation of an initial data stream to a client not corresponding to a client type in the predefined set of client types.

FIG. 3A illustrates schematically an example of implementation of a method according to the invention.

In a step 30, the server 14 obtains a set of data streams. This set of data streams may for example be obtained from a memory of the server 14 or supplied by the network gateway 12. Information representing the data streams available on the server 14 is then sent to the client 16. The client 16 selects one of the data streams available, and transmits information representing the selected data stream to the server 14. The data stream selected by the client 16 then becomes the initial data stream.

In a step 31, the server 14 receives the information representing the selected data stream transmitted by the client 16. The reception of the information representing the selected data stream serves as reception of a request for descriptive information for the initial data stream.

In a step 32, the server 14 checks that it has received information representing the capacities of the client 16. The information representing the capacities of the client 16 could have been received prior to the reception of the information representing the selected data stream or the server may, following the reception of the information representing the selected data stream, await reception of at least one item of information representing the capacities of the client 16 for a predefined time.

If, after a duration equal to the predefined time, the server 14 has not received any information representing the capacities of the client 16, it implements the HLS protocol in a step 33. An example of implementation of the HLS protocol by the server 14 is described in relation to FIGS. 3B and 3C.

If, during step 32, the server 14 finds that it has received at least one item of information representing the capacities of the client 16, it implements, during a step 34, a method allowing a fine adaptation of the initial data stream to the capacities of the client 16. An example of implementation of the method by the server 14 allowing a fine adaptation of the initial data streams to the capacities of the client 16 is described in relation to FIGS. 4A and 4B.

In one embodiment, the server 14 broadcasts the information representing the data streams available on the server 14 before having actually received the corresponding data streams. It is then the reception by the server of the request for descriptive information for a data stream that triggers the actual obtaining by the server 14 of the data stream requested.

FIGS. 3B and 3C illustrate schematically an example of implementation of the HLS protocol by the server 14.

In a step 302, the server 14 adapts the initial data stream in order to obtain a plurality of first data streams. Each first data stream is adapted to respective capacities of a client type belonging to a set of predefined client types. The capacities of a client comprise for example:
a supported video compression format. A client may for example support one or more of the following video compression formats: MPEG-2 (ISO/IEC 13818-2), MPEG-4 Part 2 (ISO/IEC 14496-2), H264/AVC (ISO/IEC 14496-10—MPEG-4 Part 10, Advanced Video Coding/ITU-T H.264), HEVC (ISO/IEC 23008-2—MPEG-H Part 2, (High-Efficiency Video Coding)/ITU-T H.265),
a supported audio compression format. A client may for example support one or more of the following audio compression formats: MP3 (MPEG-1 level III), AAC (Advanced Audio Coding),
a supported image compression format. A client may for example support one or more of the following image compression formats: JPEG (ISO/IEC 10918-1/UIT-T recommendation T.81), JPEG 2000 (ISO/IEC 15444-1),
if the client has subtitle decoding means,
a type of network used by the client: Ethernet, Wi-Fi, CPL,
a reception rate,
the maximum image resolution supported by the client,
the number of audio channels supported by the client.

A plurality of types of adaptation can be applied to an initial data stream when the first data sub-streams are obtained. When an initial data stream comprises a video stream encoded in a first video compression format, a transcoding may be applied to the video stream in order to reduce a transmission rate of said video stream and/or to reduce an image resolution of said video stream and/or to reduce an image frequency of said video stream and/or to transform said video stream so as to ensure compatibility with a second video compression format. When an initial data stream comprises an audio stream encoded in a first audio compression format, a transcoding may be applied to the audio stream in order to reduce a transmission rate of said audio stream and/or to reduce a number of channels of said audio stream and/or to transform said audio stream in order to ensure compatibility with a second audio compression format. Other types of adaptation may comprise an elimination of a subtitle stream when a client type in the predefined set of client types is not able to decode said subtitle stream.

In a step 303, the server 14 decomposes each first data stream into segments, referred to as first segments. During step 303, the server 14 associates each segment with information representing said segment comprising a URI address, a sequence number and a size of said segment.

During steps 304 and 305, the server 14 transmits to the client 16 a first item of descriptive information allowing to obtain, for each first data stream, at least one characteristic of said first data stream and for each first segment a loading address of said first segment. The first item of descriptive information enables the client 16 to request a transmission of first segments according to capacities of the client 16 in order to obtain a version of the initial data stream adapted to said capacities.

During step 304, the server 14 creates a playlist file for each first data stream. For each first data stream, the server 14 inserts the information representing each segment of said first data stream that it wishes to make accessible to the client 16 in the playlist file corresponding to said first data stream. Following the creation of the playlist files, the server 14 allocates a URI address to each playlist file. A master playlist file is next created, in which the server 14, for each first data stream, inserts the URI addresses of the playlist file corresponding to said first data stream and a description of said first data stream. A description of a first data stream included in a master playlist file may, for example, indicate for which client type in the predefined set of client types the first data stream was adapted and/or a transmission rate of the first data stream and/or an image resolution of a video stream contained in the first data stream and/or an image frequency of a video stream contained in the first data stream and/or a number of audio channels of an audio stream contained in the first data stream. Hereinafter, the server 14 associates a URI address with the master playlist file and sends this URI address to the client 16 in a step 305. This URI address being, for the client 16, the first item of descriptive information making it possible to obtain a version of the initial data stream.

In a step 311, the server 14 receives, coming from the client 16, an HTTP request containing the URI of the master playlist file. Following the reception of this request, the server 14 transmits the master playlist file to the client 16 so that it selects one of the first data streams. Following this selection, the server 14 receives an HTTP request containing the URI address of the playlist file corresponding to the first data stream selected.

In a step 312, the server 14 transmits to the client 16 the playlist file corresponding to the data stream selected.

In a step 313, the server 14 checks that it has received an HTTP request containing a URI address of a first segment requested by the client 16. If such is the case, during a step 315, the server 14 transmits the first requested segment to the client 16 and returns to step 313. If no HTTP request for a new segment is received during a predefined time or the last segment transmitted is a final segment of the first data stream, the server 14 ends the broadcasting of the first data stream during a step 314.

FIG. 3D illustrates schematically an example of implementation of the HLS protocol by the client 16. The client 16 is supposed to have selected an initial data stream from a set of data streams available in the server 14. In this example, the client 16 has not transmitted its capacities to the server 14. The client 16 has therefore received the URI address of the master playlist file corresponding to the selected initial data stream transmitted during step 305.

In a step 321, at a moment chosen for example by a user of the client 16, the client 16 transmits an HTTP request to the server 14 containing the URI address of the master playlist file corresponding to the initial data stream that it selected. In return, the client 16 receives said master playlist file from the server 14. The client 16 then selects a first data stream from the first data streams mentioned in the master playlist file using the descriptions of each first data stream. During this selection, the client 16 compares the capacities of said client 16 with the information contained in the descriptions of each first data stream. If the client 16 corresponds to a client type included in the predefined set of client types, the client 16 chooses the first data stream corresponding to this client type in the predefined set. If the client 16 does not correspond to a client type represented in the set of predefined client types, the client 16 chooses a first data stream having characteristics as close as possible to the capacities of the client 16.

After having selected one of the first data streams, the client 16 transmits to the server 14 a request containing the URI address of the playlist file corresponding to the first data stream selected.

In a step 322, the client 16 receives the playlist file corresponding to the first data stream that it selected.

In a step 323, the client 16 seeks in the playlist file a first segment to be requested to the server 14. When the client 16 for the first time requests a first segment for the first data stream that it selected, the client 16 in general selects the first segment having the lowest sequence number in the playlist file that it received.

In a step 324, the client 16 transmits an HTTP request to the server 14 containing the URI address of said first segment selected.

In a step 325, the client 16 receives said first segment and supplies this first segment to a decoding module responsible for decoding of the first segment.

In a step 326, the client 16 checks whether the broadcasting of the initial data stream that it selected must be continued. The broadcasting of a data stream may, for example, be controlled by a user of the client 16. If the broadcasting must be continued, the client 16 once again implements step 323 and requests the first segment following the first segment previously requested, i.e. the first segment having a sequence number incremented by one unit with respect to the sequence number of the first segment previously requested. If the broadcasting must not be continued, the client 16 ends it in a step 327.

In an embodiment suited to a client having capacities varying over time, during step 321 the client 16 can transmit to the server 14 an HTTP request containing all the URI addresses contained in the master playlist file. In this way, the client 16 receives each playlist file corresponding to the initial data stream that it selected. During step 326, if the broadcasting of the initial data stream must be continued, the client 16 selects a first data stream compatible with capacities of the client 16 found at the time of implementation of step 326. The client 16 next selects the next segment to be requested to the server in the playlist file corresponding to the first data stream selected during step 326.

The example implementation of the HLS protocol described in relation to FIGS. 3B, 3C and 3D shows that the current HLS protocol does not allow a fine adaptation of the data stream to the capacities of the client 16.

FIGS. 4A and 4B illustrate schematically an example of an implementation by the server 14 of a method for streaming a data stream allowing a fine adaptation of the data stream to the capacities of a client. This method corresponds to step 34 described in relation to FIG. 3A.

In a step 402 following step 32, in the same way as the server 14 had adapted the initial data stream to the respective capacities of the client types in the predefined set of client types for obtaining the first data streams, the server 14 adapts the initial data stream to each capacity of the client 16 received for obtaining a second data stream.

In a step 403, the server 14 decomposes the second data stream into segments, referred to as second segments. Each second segment is associated with a URI address.

During steps 404 and 405, the server 14 transmits to the client 16 a second item of descriptive information making it possible to obtain, for each second segment, the URI address of said second segment. The second item of descriptive information enables the client 16 to request a transmission of the second segments in order to obtain the second data stream.

In step 404, the server 14 creates a playlist file and inserts therein the URI addresses, the sequence numbers and the durations of the second segments. The server 14 next allocates a URI address to the playlist file thus created.

During step 405, the URI address of the playlist file containing the URI addresses of the second segment is transmitted to the client 16. The URI address of the playlist file containing the URI addresses of the second segments corresponds to the second item of descriptive information enabling the client 16 to request a transmission of the second segments in order to obtain the second data stream.

In a step 411, the server 14 receives an HTTP request coming from the client 16 containing the URI address of the playlist file containing the URI addresses of the second segments.

In a step 412, the server 14 transmits the playlist file containing the URI addresses of the second segments to the client 16.

In a step 415, following a reception, in a step 413, of an HTTP request containing a URI address of a second segment coming from the client 16, the server 14 transmits to the client 16 the second segment corresponding to said URI address. The URI address of said second segment was obtained by the client 16 from the playlist file transmitted by the server 14.

If during step 413 no HTTP request for a new segment is received during a predetermined time or the last segment transmitted is a final segment of the second data stream, the server 14 ends the broadcasting of the second data stream during a step 414.

FIG. 4C illustrates schematically an example of an implementation by a client of the method for streaming a data stream allowing a fine adaptation of the data stream to the capacities of the client.

In a step 420, the client 16 transmits to the server 14 information representing its capacities.

In a step 421, at a moment chosen for example by a user of the client 16, the client 16 transmits an HTTP request to the server 14 containing the URI address of the playlist file containing the URI addresses of the second segments. In return, the client 16 receives said playlist file from the server 14 during a step 422.

In a step 423, the client 16 seeks in the playlist file a second segment to be requested from the server 14. When the client 16 first requests a second segment, the client 16 in general selects the second segment having the lowest sequence number in the playlist file that it has received.

In a step 424, the client 16 transmits an HTTP request to the server 14 containing the URI address of said second segment selected.

In a step 425, the client 16 receives said second segment and supplies this second segment to a decoding module responsible for decoding the second segment.

In a step 426, the client 16 checks whether the broadcasting of the initial data stream that it selected must be continued. If the broadcasting must be continued, the client 16 once again executes step 423 and requests the second segment following the previously requested segment, i.e. the second segment having a sequence number incremented by one unit with respect to the sequence number of the second segment previously requested. If the broadcasting must not be continued, the client 16 ends it during a step 427.

In one embodiment, the client 16 can open an HTTP connection with the server 14 in order to transmit its capacities. This connection can be closed by the server as soon as the capacities of the client 16 are received.

In one embodiment, the method described in relation to FIG. 4C could be implemented by a second client not shown in FIG. 1. In this case the client 16 would be compatible with the HLS protocol whereas the second client would be compatible with the HLS protocol and the method described in relation to FIGS. 4A, 4B and 4C.

In one embodiment, during step 402, the server 14 also generates first data streams as described in relation to step 302. During step 403, the server 14 also generates first segments as described in relation to step 303. During step 404, the server 14 also generates a playlist file for each first data stream as described in relation to step 304. The URI addresses of the playlist files corresponding to the first data streams and to the second data stream are inserted in a master playlist file. During step 405, the URI address of the master playlist file is transmitted to the client 16. In this embodiment, the client 16 can choose, from the first data streams and the second data streams, the data stream most appropriate to its capacities at a given instant. In this embodiment, a client other than the client 16 could also receive the master playlist file and choose, from the first data streams and the second data stream, the data stream most appropriate to its capacities. Thus a client not implementing the method described in relation to FIG. 3 but only the HLS protocol, could receive the second data stream if its capacities are closer to those of the client 16 than to those of the client types in the predefined set of client types.

In one embodiment, the client 16 can send to the server 14 new information representing its capacities at regular intervals or when its capacities have changed significantly with respect to the last capacities sent. The sending of new information representing capacities of the client 16 causes a new adaptation of the initial data stream by the server 14 in order to generate a new second data stream adapted to the new capacities.

FIG. 2A illustrates schematically an example of hardware architecture of a client device implementing the HLS protocol and/or the method described in relation to FIG. 4C. We take here the example of the client 16. The client 16 then comprises, connected by a communication bus 165: a processor or CPU (central processing unit) 160; a random access memory (RAM) 161; a read only memory (ROM) 162; a storage unit or storage-medium reader, such an as SD (secure digital) card reader 163; a set 164 of connection interfaces for connecting the client 16 to the server 14.

The processor 160 is capable of executing instructions loaded in the RAM 161 from the ROM 162, from an external memory (not shown), from a storage medium such as an SD card, or from a communication network. When the client 16 is powered up, the processor 160 is capable of reading instructions from the RAM 161 and executing them. These instructions form a computer program causing the implementation, by the processor 160, of all or some of the methods described in relation to FIGS. 3C and 4C.

FIG. 2B illustrates schematically an example of hardware architecture of a server device implementing the invention. We take here the example of the server 14. The server 14 then comprises, connected by a communication bus 145: a processor or CPU (central processing unit) 140; a random access memory (RAM) 141; a read only memory (ROM) 142; a storage unit or storage-medium reader, such an as SD (secure digital) card reader 143; a set 144 of connection interfaces for connecting the server 14 to the client 16 and to the network gateway 12.

The processor 140 is capable of executing instructions loaded in the RAM 141 from the ROM 142, from an external memory (not shown), from a storage medium such as an SD card, or from a communication network. When the server 14 is powered up, the processor 140 is capable of reading instructions from the RAM 141 and executing them. These instructions form a computer program causing the implementation, by the processor 140, of all or some of the methods described in relation to FIGS. 3A, 3B, 4A and 4B.

All or part of the algorithm described in relation to FIGS. 3A, 3B, 3C, 4A, 4B and 4C can be implemented in software form by the execution of a set of instructions by a programmable machine such as a DSP (digital signal processor) or a microcontroller, or be implement in hardware form by a machine or a dedicated component such as an FPGA (field-programmable gate array) or an ASIC (application-specific integrated circuit).

1. A method for transmitting a data stream between a client and a server using a streaming protocol, wherein the method comprises the following steps implemented by the server:
obtaining an initial data stream;
receiving a request for descriptive information for the initial data stream from said client;
checking that at least one item of information representing a capacity of said client has been received from said client;
if no information representing a capacity of said client has been received:
adapting the initial data stream in order to obtain a plurality of first data streams, each first stream being adapted to respective capacities of a client type belonging to a set of predefined client types;
decomposing each first data stream into segments, referred to as first segments; and
transmitting to said client a first item of descriptive information enabling the client to request a transmission of first segments of at least one first data stream;
and, if at least one item of information representing a capacity of said client has been received:
adapting said initial data stream to each capacity received in order to obtain a second data stream;
decomposing the second data stream into segments, referred to as second segments; and
transmitting to the client a second item of descriptive information enabling the client to request a transmission of second segments of the second data stream.

2. The method according to claim 1, wherein the streaming protocol is the streaming protocol based on HTTP.

3. The method according to claim 2, wherein the second item of descriptive information is put in the form of a playlist file compatible with the streaming protocol (404).

4. The method according to claim 3, wherein the transmission of the second item of descriptive information comprises a transmission to the client of a loading address of the playlist file compatible with the streaming protocol.

5. The method according to claim 4, wherein the server transmits the playlist file compatible with the streaming protocol to the client, following a reception, coming from the client, of an HTTP request containing said loading address.

6. The method according to claim 5, wherein the server transmits a second segment following a reception, coming from the client, of an HTTP request containing a loading address corresponding to said second segment, said loading address having been obtained from the text file compatible with the streaming protocol.

7. The method according to claim 1, wherein the capacities of the client comprise a supported video compression format and/or a supported audio compression format and/or a supported image compression format and/or a supported subtitle format and/or a type of network used and/or a reception rate and/or a supported maximum image resolution and/or a number of supported audio channels.

8. The method according to claim 1, wherein when said initial data stream comprises a video stream encoded in a first video compression format, an adaptation of said initial data stream comprises a transcoding for reducing a transmission rate of said video stream and/or an image resolution of said video stream and/or a transformation of said video stream so as to ensure compatibility with a second video compression format, and, when said initial data stream comprises an audio stream encoded in a first audio compression format, an adaptation of said initial data stream comprises a transcoding for reducing a transmission rate of said audio stream and/or a number of channels and/or a transformation of said audio stream in order to ensure compatibility with a second audio compression format.

9. A device of the server type able to transmit a data stream using a streaming protocol, wherein the device comprises circuitry adapted for:
obtaining an initial data stream;
receiving a descriptive information request for the initial data stream from a client;
verifying that at least one item of information representing a capacity of said client has been received;
adapting the initial data stream for obtaining a plurality of first data streams when no information representing a capacity of said client has been received, each first data stream being adapted to respective capacities of a client type belonging to a predefined set of client types;
decomposing each first data stream into segments, referred to as first segments; and
transmitting to a client a first item of descriptive information enabling the client to request a transmission of the first segments of at least one first data stream;
adapting said initial data stream to each capacity received in order to obtain a second data stream when at least one item of information representing a capacity of said client has been received;
decomposing the second data stream into segments, referred to as second segments; and
transmitting to the client a second item of descriptive information enabling the client to request a transmission of second segments of the second data stream.

10. A device of the client type able to receive a data stream using the streaming protocol based on HTTP, wherein the device comprises circuitry adapted for:
transmitting at least one item of information representing a capacity of said client device to a server;
receiving a text file compatible with the streaming protocol based on HTTP, the text file corresponding to an initial data file and allowing to be obtained loading addresses of segments corresponding to a data stream, referred to as the second data stream, resulting from an adaptation by the server of the initial data stream to each capacity of said client-type device;
transmitting a request containing a loading address of a segment of the second data stream, the loading address having been obtained from the text file compatible with the streaming protocol based on HTTP; and
receiving the segment corresponding to the request transmitted.

11. A system for transmitting a data stream, comprising a device of server type according to claim 9 and a client device of the client type able to receive a data stream using the streaming protocol based on HTTP,
wherein the client device of the client type comprises circuitry adapted for:
transmitting at least one item of information representing a capacity of said client device to a server;
receiving a text file compatible with the streaming protocol based on HTTP, the text file corresponding to an initial data file and allowing to be obtained loading addresses of segments corresponding to a data stream, referred to as the second data stream, resulting from an adaptation by the server of the initial data stream to each capacity of said client-type device;
transmitting a request containing a loading address of a segment of the second data stream, the loading address having been obtained from the text file compatible with the streaming protocol based on HTTP; and
receiving the segment corresponding to the request transmitted.

12. A computer program product, comprising a non-transitory computer readable medium embodying instructions for the implementation, by a device, of the method according to claim 1 when said program is executed by a processor of the device.

13. A non-transitory storage means, storing a computer program comprising instructions for the implementation, by a device, of the method according to claim 1 when said program is executed by a processor of said device.
